(19) United States
(12) Patent Application Publication
(10) Pub. No.: US 2024/0223013 A1
(43) Pub. Date: Jul. 4, 2024

(54) Bidirectional Power Supply and Control Method

(71) Applicant: AA Power Inc., Boston, MA (US)

(72) Inventor: Qun Lu, Lexington, MA (US)

(21) Appl. No.: 18/392,331

(22) Filed: Dec. 21, 2023

Related U.S. Application Data
(60) Provisional application No. 63/477,856, filed on Dec. 30, 2022.

(51) Int. Cl. H02J 50/12; H02J 7/00; H02J 50/70; H02M 3/335

(52) U.S. Cl. CPC H02J 50/12; H02J 7/0068; H02J 50/70; H02M 3/33584; H02J 2207/20

(57) ABSTRACT

A bidirectional power conversion system includes from a first port to a second port, a first power converter configured to provide power across a first isolation barrier, and from the second port to a third port, a second power converter configured to provide power across a second isolation barrier, wherein the first power converter and the second power converter mounted adjacent to each other on a platform, and at least one auxiliary component is shared by the first power converter and the second power converter.

### RELATED APPLICATION

This application claims the benefit of U.S. Provisional Application No. 63/477,856, filed on Dec. 30, 2022, entitled “Bidirectional Power Supply and Control Method,” which application is hereby incorporated herein by reference.

### TECHNICAL FIELD

The present invention relates to a bidirectional power supply and control method, and, in particular embodiments, to a bidirectional power supply for efficiently supplying power for energy storage power applications.

### BACKGROUND

A power system is an interconnected network comprising a variety of power sources, transmission lines, distribution centers and loads. The interconnected network formed by the power sources, transmission lines, distribution centers and loads is commonly known as the grid. The power sources are used to generate electric power. The power sources may be power generators utilize different technologies such as solar energy sources (e.g., solar panels), wind generators (e.g., wind turbines), combined heat and power systems, marine energy, geothermal, biomass, fuel cells, micro-turbines and/or the like.

Power demand in a power system may vary within one day. The demand may peak during daytime and early evening hours and drop dramatically during the night. On the other hand, due to the nature of renewable energy, the outputs of some power sources such as solar panels and wind turbines may vary considerably depending on uncontrollable natural factors such as wind strength and/or the like. In order to provide reliable and stable power to critical loads, the power system may include a plurality of energy storage units such as batteries. The energy storage units are designed so as to be capable of converting excess capacity into stored energy during off-peak hours and recovering the stored energy and converting it back to electricity during peak hours.

An energy storage system includes a power conversion system and a battery storage unit. In operation, the power conversion system is able to convert power supplied from various energy sources into a voltage suitable for being stored in the battery storage unit. On the other hand, the power conversion system is able to convert the battery power into a suitable voltage for various loads or power sources coupled to the energy storage system. At this time, the energy conversion is required in both directions between the battery and the input of the energy storage system. A bidirectional power supply such as a bidirectional dc/dc converter is commonly used to achieve the energy conversion in both directions. The bidirectional power supply is also applicable to the power grid. For example, energy is fed into the power grid and retrieved from the power grid through the bidirectional power supply.

### SUMMARY

These and other problems are generally solved or circumvented, and technical advantages are generally achieved, by preferred embodiments of the present disclosure which provide a bidirectional power supply and control method.

In accordance with an embodiment, a power conversion system comprises from a first port to a second port, a first power converter configured to provide power across a first isolation barrier, and from the second port to a third port, a second power converter configured to provide power across a second isolation barrier, wherein the first power converter and the second power converter mounted adjacent to each other on a platform, and at least one auxiliary component is shared by the first power converter and the second power converter.

In accordance with another embodiment, a system comprises a first power converter coupled between a first terminal and a second terminal of the system, wherein the first power converter is configured to provide power across a first isolation barrier, and a second power converter coupled between the second terminal and a third terminal of the system, wherein the second power converter is configured to provide power across a second isolation barrier, and wherein the first power converter and the second power converter mounted adjacent to each other on a printed circuit board.

In accordance with yet another embodiment, a bidirectional power system comprises a first power converter coupled between a first terminal and a second terminal on a printed circuit board, wherein the first power converter is configured to provide power from the first terminal to the second terminal across a first isolation barrier, and a second power converter coupled between the second terminal and a third terminal on the printed circuit board, wherein the second power converter is configured to provide power from the second terminal to the third terminal across a second isolation barrier, and wherein the first power converter comprises at least one first magnetic device, and the second power converter comprises at least one second magnetic device, and wherein the at least one first magnetic device is magnetically coupled to the at least one second magnetic device.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a first implementation of the bidirectional power conversion system in accordance with various embodiments of the present disclosure;

FIG. 2 illustrates a block diagram of a second implementation of the bidirectional power conversion system in accordance with various embodiments of the present disclosure;

FIG. 3 illustrates a block diagram of a third implementation of the bidirectional power conversion system in accordance with various embodiments of the present disclosure;

FIG. 4 illustrates a block diagram of a fourth implementation of the bidirectional power conversion system in accordance with various embodiments of the present disclosure;

FIG. 5 illustrates a first implementation of the control circuits of the bidirectional power conversion system in accordance with various embodiments of the present disclosure;

FIG. 6 illustrates a second implementation of the control circuits of the bidirectional power conversion system in accordance with various embodiments of the present disclosure;

FIG. 7 illustrates a first implementation of the layout of the bidirectional power conversion system in accordance with various embodiments of the present disclosure;

FIG. 8 illustrates a second implementation of the layout of the bidirectional power conversion system in accordance with various embodiments of the present disclosure;

FIG. 9 illustrates a third implementation of the layout of the bidirectional power conversion system in accordance with various embodiments of the present disclosure;

FIG. 10 illustrates a fourth implementation of the layout of the bidirectional power conversion system in accordance with various embodiments of the present disclosure;

FIG. 11 illustrates a fifth implementation of the layout of the bidirectional power conversion system in accordance with various embodiments of the present disclosure;

FIG. 12 illustrates a sixth implementation of the layout of the bidirectional power conversion system in accordance with various embodiments of the present disclosure;

FIG. 13 illustrates a seventh implementation of the layout of the bidirectional power conversion system in accordance with various embodiments of the present disclosure;

FIG. 14 illustrates an eighth implementation of the layout of the bidirectional power conversion system in accordance with various embodiments of the present disclosure;

FIG. 15 illustrates a schematic diagram of a first implementation of the power converters of the bidirectional power conversion system in accordance with various embodiments of the present disclosure;

FIG. 16 illustrates a schematic diagram of a second implementation of the power converters of the bidirectional power conversion system in accordance with various embodiments of the present disclosure;

FIG. 17 illustrates a schematic diagram of a third implementation of the power converters of the bidirectional power conversion system in accordance with various embodiments of the present disclosure; and

FIG. 18 illustrates a schematic diagram of a fourth implementation of the power converters of the bidirectional power conversion system in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context, namely a bidirectional power conversion system and control method. The disclosure may also be applied, however, to a variety of power conversion systems. Hereinafter, various embodiments will be explained in detail with reference to the accompanying drawings.

A bidirectional power conversion system comprises a first power converter and a second power converter. The first power converter is coupled between a first port and a second port of the bidirectional power conversion system. The second power converter is coupled between the second port and a third port of the bidirectional power conversion system. In operation, from the first port to the second port, the first power converter is configured to provide power across a first isolation barrier. In some embodiments, the first isolation barrier is provided by a first transformer. In operation, from the second port to the third port, the second power converter configured to provide power across a second isolation barrier. In some embodiments, the second isolation barrier is provided by a second transformer.

In some embodiments, the first power converter and the second power converter are mounted adjacent to each other on a platform. In some embodiments, the platform is implemented as a printed circuit board. Furthermore, the first power converter and the second power converter are packaged in a same packaging house.

In some embodiments, at least one auxiliary component is shared by the first power converter and the second power converter. For example, the first power converter and the second power converter may share a controller, a head sink, an auxiliary power source, a cooling fan, a magnetic component and the like.

In some embodiments, the first power converter is a first full bridge converter. The second power converter is a second full bridge converter. In alternative embodiments, the first power converter is a first forward converter. The second power converter is a second forward converter. Furthermore, the first power converter is a full bridge converter. The second power converter is a forward converter.

In some embodiments, the first power converter comprises a first magnetic component. The second power converter comprises a second magnetic component. The first magnetic component and the second magnetic component are adjacent to each other. A longitudinal direction of the first magnetic component is in parallel with a longitudinal direction of the second magnetic component. In addition, a current flowing through the first magnetic component and a current flowing through the second magnetic component are configured such that radiation electromagnetic interference (EMI) of the first magnetic component and radiation EMI of the second magnetic component cancel each other out.

In some embodiments, primary side circuits of the first power converter and secondary side circuits of the second power converter share a first heat sink. Secondary side circuits of the first power converter and primary side circuits of the second power converter share a second heat sink. In alternative embodiments, the first power converter and the second power converter share a same heat sink. An isolation layer is formed on the same heat sink to provide the isolation.

In some embodiments, a first controller is configured to control the primary side circuits of the first power converter and the secondary side circuits of the second power converter. A second controller is configured to control the secondary side circuits of the first power converter and the primary side circuits of the second power converter.

In some embodiments, the first power converter and the second power converter share a same auxiliary power source.

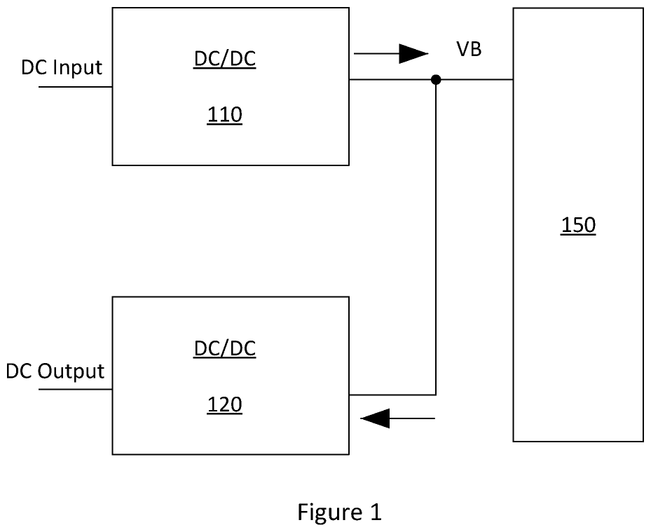

FIG. 1 illustrates a block diagram of a first implementation of the bidirectional power conversion system in accordance with various embodiments of the present disclosure. The bidirectional power conversion system comprises a first power converter 110 coupled between a first port (DC Input) and a second port (VB), and a second power converter 120 coupled between the second port (VB) and a third port (DC Output). As shown in FIG. 1, the first power converter 110 is a first dc/dc converter. The second power converter 120 is a second dc/dc converter. The first port is configured to receive a de input voltage. The second port is configured to maintain a dc voltage for a load or a downstream converter 150. The third port is configured to generate a dc output voltage.

In operation, in a first phase of the bidirectional power conversion system, the power flows from the first port to the second port. In a second phase of the bidirectional power conversion system, the power flows from the second port to the third port.

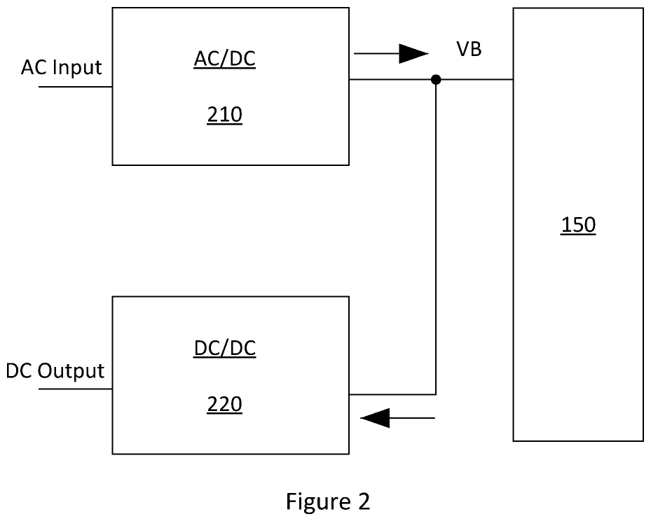

FIG. 2 illustrates a block diagram of a second implementation of the bidirectional power conversion system in accordance with various embodiments of the present disclosure. The bidirectional power conversion system comprises a first power converter 210 coupled between a first port (AC Input) and a second port (VB), and a second power converter 220 coupled between the second port (VB) and a third port (DC Output). As shown in FIG. 2, the first power converter 210 is an ac/dc converter. The second power converter 220 is a dc/dc converter. The first port is configured to receive an ac input voltage. The second port is configured to maintain a dc voltage for a load or a downstream converter 150. The third port is configured to generate a dc output voltage.

In operation, in a first phase of the bidirectional power conversion system, the power flows from the first port to the second port. In a second phase of the bidirectional power conversion system, the power flows from the second port to the third port.

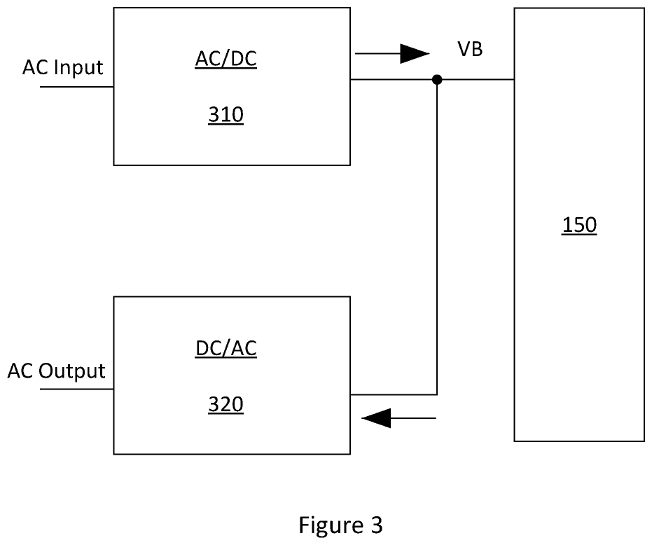

FIG. 3 illustrates a block diagram of a third implementation of the bidirectional power conversion system in accordance with various embodiments of the present disclosure. The bidirectional power conversion system comprises a first power converter 310 coupled between a first port (AC Input) and a second port (VB), and a second power converter 320 coupled between the second port (VB) and a third port (AC Output). As shown in FIG. 3, the first power converter 310 is an ac/dc converter. The second power converter 320 is a dc/ac converter. The first port is configured to receive an ac input voltage. The second port is configured to maintain a dc voltage for a load or a downstream converter 150. The third port is configured to generate an ac output voltage.

In operation, in a first phase of the bidirectional power conversion system, the power flows from the first port to the second port. In a second phase of the bidirectional power conversion system, the power flows from the second port to the third port.

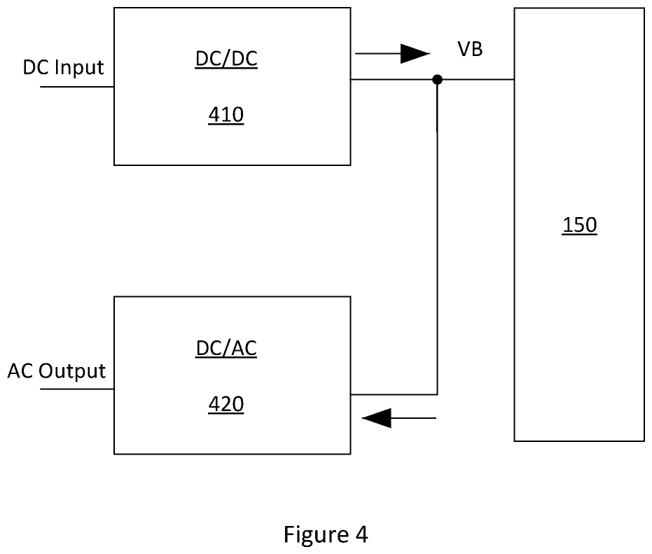

FIG. 4 illustrates a block diagram of a fourth implementation of the bidirectional power conversion system in accordance with various embodiments of the present disclosure. The bidirectional power conversion system comprises a first power converter 410 coupled between a first port (DC Input) and a second port (VB), and a second power converter 420 coupled between the second port (VB) and a third port (AC Output). As shown in FIG. 4, the first power converter 410 is a dc/dc converter. The second power converter 420 is a dc/ac converter. The first port is configured to receive a de input voltage. The second port is configured to maintain a dc voltage for a load or a downstream converter 150. The third port is configured to generate an ac output voltage.

In operation, in a first phase of the bidirectional power conversion system, the power flows from the first port to the second port. In a second phase of the bidirectional power conversion system, the power flows from the second port to the third port.

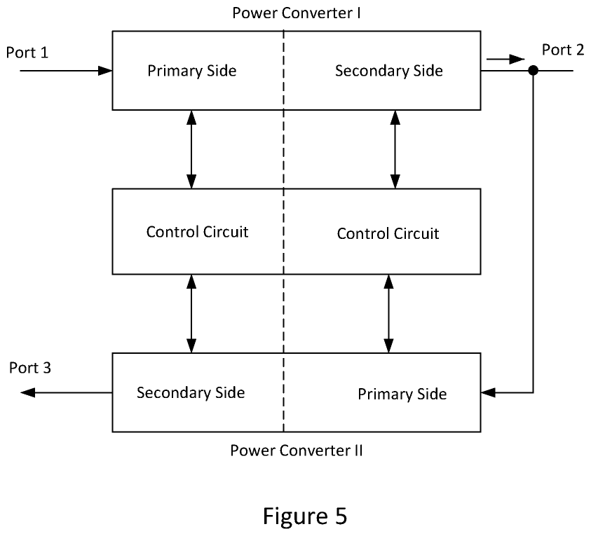

FIG. 5 illustrates a first implementation of the control circuits of the bidirectional power conversion system in accordance with various embodiments of the present disclosure. The bidirectional power conversion system comprises a first power conversion unit and a second power conversion unit. As shown in FIG. 5, power flows from an input port (e.g., a de or an ac input) to a first output port (e.g., a battery, an ac/dc converter or a dc/dc converter) through the first power conversion unit. The first power conversion unit comprises a primary side circuit and a secondary side circuit. The dashed line indicates there is an isolation barrier between the primary side circuit and the secondary side circuit. The primary side circuit of the first power conversion unit is controlled by a first primary control circuit. The secondary side circuit of the first power conversion unit is controlled by a first secondary control circuit.

As shown in FIG. 5, power flows from the output (e.g., the battery) to a second output port (e.g., a dc or ac output) through the second power conversion unit. The second power conversion unit comprises a primary side circuit and a secondary side circuit. The dashed line indicates there is an isolation barrier between the primary side circuit and the secondary side circuit. The primary side circuit of the second power conversion unit is controlled by a second primary control circuit. The secondary side circuit of the second power conversion unit is controlled by a second secondary control circuit.

The first primary control circuit and the second secondary control circuit are on the left side of the isolation barrier. The second primary control circuit and the first secondary control circuit are on the right side of the isolation barrier. In some embodiments, the first primary control circuit and the second secondary control circuit are integrated on a first integrated circuit (IC). The second primary control circuit and the first secondary control circuit are integrated on a second IC. In alternative embodiments, the first primary control circuit, the second secondary control circuit, the second primary control circuit and the first secondary control circuit are integrated on a same IC. More particularly, the first primary control circuit and the second secondary control circuit are integrated on a first portion of this IC. The second primary control circuit and the first secondary control circuit are integrated on a second portion of this IC. This is an isolation barrier inside the IC. The first portion and the second portion are separated by this isolation barrier. Furthermore, one control IC is able to control the primary circuit and the secondary circuit. More particularly, this control IC is configured to control the primary side circuits of the first power converter and the secondary side circuits of the second power converter directly, and control the secondary side circuits of the first power converter and the primary side circuits of the second power converter through an isolator (e.g., a signal transformer, an opto-coupler, a digital isolator and the like).

In operation, a battery is coupled to the second output port. In a first phase of the power conversion system, the first power conversion unit is configured to charge the battery. In a second phase of the power conversion system, the second power conversion unit is configured to provide a discharge path for the battery.

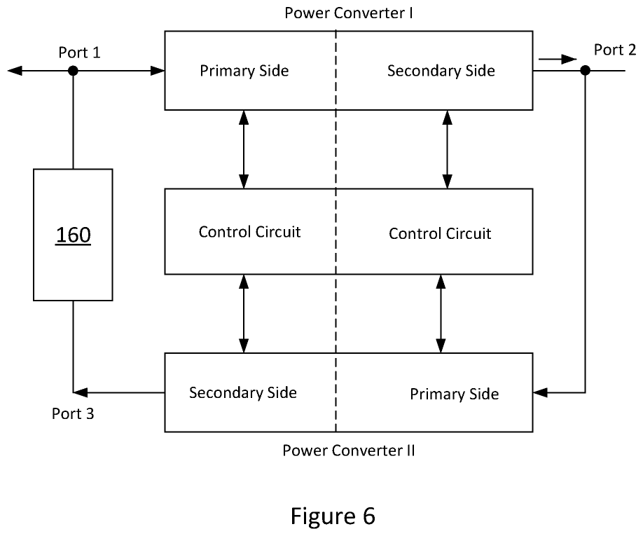

FIG. 6 illustrates a second implementation of the control circuits of the bidirectional power conversion system in accordance with various embodiments of the present disclosure. The second implementation of the control circuits of the bidirectional power conversion system is similar to that shown in FIG. 5 except that a selector circuit 160 is employed to further control the power delivery path.

In some embodiments, an energy storage unit is coupled to the second port (Port 2). In a first phase of the power conversion system, the first power conversion unit is configured to charge the energy storage unit. In a second phase of the power conversion system, the second power conversion unit is configured to provide a discharge path for the energy storage unit.

The selector circuit 160 is coupled between the first port (Port 1) and the third port (Port 3). The selector circuit is configured such that in the first phase of the power conversion system, the first port is separated from the third port, and in the second phase of the power conversion system, the first port is connected to the third port.

One advantageous feature of having the bidirectional power conversion systems shown in FIGS. 1-6 is that due to the physical topology and different applications, the independent converters for bidirectional applications can be designed as needed. For example, charging capacity and discharge capacity for a typical battery pack application are different. In particular, the charging demand is 500 W. The discharge demand is 1500 W. In the bidirectional power conversion systems shown in FIGS. 1-6, the systems can be designed as needed for each direction so as to avoid overdesign.

Another advantageous feature of having the bidirectional power conversion systems shown in FIGS. 1-6 is that the systems can improve reliability. Because the two power converters are completely decoupled from physics and function, one failed power converter has no impact on the other power converter.

Another advantageous feature of having the bidirectional power conversion systems shown in FIGS. 1-6 is that an energy storage inverter (AC output, which can be off-grid or grid-connected with load) can provide a real UPS function. Charging and discharging can be performed at the same time. When the charging is interrupted for some reasons, the discharge module will not have the AC power-down risk, thereby achieving a seamless transition. This feature is important for uninterruptible applications with high reliable requirements such as some medical equipment, storage or network server applications.

Another advantageous feature of having the bidirectional power conversion systems shown in FIGS. 1-6 is that because charging and discharging can be realized at the same time, during manufacturing burn-in stage, the load energy can be recycled easily by internal circulation energy. This only needs an external small power supply to support the loss of the device, thereby greatly reducing the power load of the aging test, and eliminating expensive special energy recycle equipment.

Another advantageous feature of having the bidirectional power conversion systems shown in FIGS. 1-6 is that since the direction power conversion units are implemented as physically separated topologies, each direction design can be optimized based on this direction requirement. As a result, the bi-directional functions can be optimized.

Another advantageous feature of having the bidirectional power conversion systems shown in FIGS. 1-6 is that due to the use of two sets of physical topologies, in principle, many common parts can be shared with two converters. The common parts include heatsink, housing, PCB, housing keeping power supplier, fan, magnetic and the like.

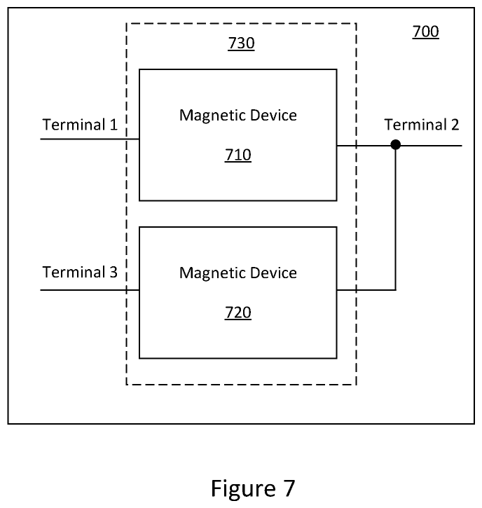

FIG. 7 illustrates a first implementation of the layout of the bidirectional power conversion system in accordance with various embodiments of the present disclosure. The bidirectional power conversion system comprises a first power converter and a second power converter. These two power converters are on a printed circuit board 700. The first power converter comprises a magnetic device 710. The magnetic device 710 is coupled between a first terminal (Terminal 1) and a second terminal (Terminal 2). In some embodiments, the magnetic device 710 is a transformer. In alternative embodiments, the magnetic device 710 is an integrated magnetic device comprising a transformer and an inductor. The second power converter comprises a magnetic device 720. The magnetic device 720 is coupled between the second terminal and a third terminal (Terminal 3). In some embodiments, the magnetic device 720 is a transformer. In alternative embodiments, the magnetic device 720 is an integrated magnetic device comprising a transformer and an inductor.

In some embodiments, the magnetic device 710 is magnetically coupled to the magnetic device 720. Furthermore, the magnetic device 710 and the magnetic device 720 are placed in parallel on the printed circuit board 700. In particular, a longitudinal direction of the magnetic device 710 is in parallel with a longitudinal direction of the magnetic device 720. As shown in FIG. 7, a first shorter side of the magnetic device 710 is aligned with a first shorter side of the magnetic device 720. A second shorter side of the magnetic device 710 is aligned with a second shorter side of the magnetic device 720. The arrangement shown in FIG. 7 helps to reduce EMI. More particularly, radiation EMI of the magnetic device 710 and radiation EMI of the magnetic device 720 cancel each other out.

In some embodiments, the magnetic device 710 and the magnetic device 720 are integrated into one magnetic core structure. A current flowing through the magnetic device 710 and a current flowing through the magnetic device 720 are configured so as to reduce power losses through flux cancellation.

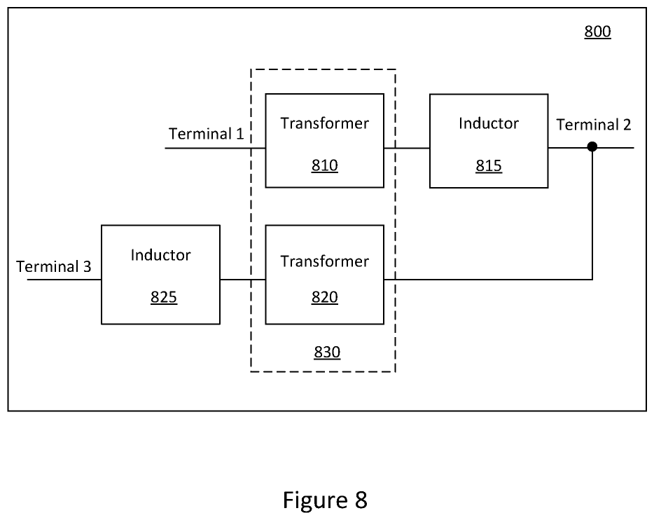

FIG. 8 illustrates a second implementation of the layout of the bidirectional power conversion system in accordance with various embodiments of the present disclosure. The bidirectional power conversion system comprises a first power converter and a second power converter. These two power converters are on a printed circuit board 800. The first power converter comprises a transformer 810 and an inductor 815. The transformer 810 and the inductor 815 are coupled in cascade between a first terminal (Terminal 1) and a second terminal (Terminal 2). The second power converter comprises a transformer 820 and an inductor 825. The transformer 820 and the inductor 825 are coupled in cascade between the second terminal and a third terminal (Terminal 3).

In some embodiments, the transformer 810 is magnetically coupled to the transformer 820 to form a coupled magnetic device 830. The inductor 815 and the inductor 825 are on opposite sides of the coupled magnetic device 830. As shown in FIG. 8, the transformer 810 and the transformer 820 are placed in parallel on the printed circuit board. In particular, a longitudinal direction of the transformer 810 is in parallel with a longitudinal direction of the transformer 820. As shown in FIG. 8, a first shorter side of the transformer 810 is aligned with a first shorter side of the transformer 820. A second shorter side of the transformer 810 is aligned with a second shorter side of the transformer 820. The arrangement shown in FIG. 8 helps to reduce EMI. More particularly, radiation EMI of the transformer 810 and radiation EMI of the transformer 820 cancel each other out.

It should be noted that in FIG. 8 each rectangle represents an area occupied by a corresponding magnetic device.

In some embodiments, the transformer 810 and the transformer 820 are integrated into one magnetic core structure. A current flowing through the transformer 810 and a current flowing through the transformer 820 are configured so as to reduce power losses through flux cancellation.

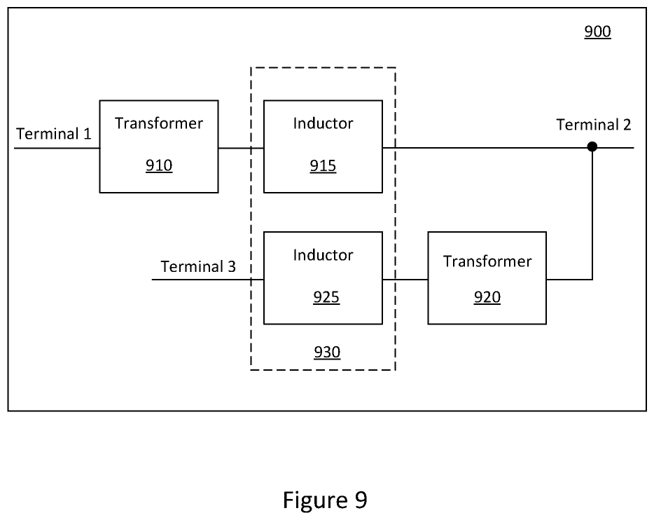

FIG. 9 illustrates a third implementation of the layout of the bidirectional power conversion system in accordance with various embodiments of the present disclosure. The bidirectional power conversion system comprises a first power converter and a second power converter. These two power converters are on a printed circuit board 900. The first power converter comprises a transformer 910 and an inductor 915. The transformer 910 and the inductor 915 are coupled in cascade between a first terminal (Terminal 1) and a second terminal (Terminal 2). The second power converter comprises a transformer 920 and an inductor 925. The transformer 920 and the inductor 925 are coupled in cascade between the second terminal and a third terminal (Terminal 3).

In some embodiments, the inductor 915 is magnetically coupled to the inductor 925 to form a coupled magnetic device 930. The transformer 910 and the transformer 920 are on opposite sides of the coupled magnetic device 930. As shown in FIG. 9, the inductor 915 and the inductor 925 are placed in parallel on the printed circuit board. In particular, a longitudinal direction of the inductor 915 is in parallel with a longitudinal direction of the inductor 925. As shown in FIG. 9, a first shorter side of the inductor 915 is aligned with a first shorter side of the inductor 925. A second shorter side of the inductor 915 is aligned with a second shorter side of the inductor 915. The arrangement shown in FIG. 9 helps to reduce EMI. More particularly, radiation EMI of the inductor 915 and radiation EMI of the inductor 925 cancel each other out.

It should be noted that in FIG. 9 each rectangle represents an area occupied by a corresponding magnetic device.

In some embodiments, the inductor 915 and the inductor 925 are integrated into one magnetic core structure. A current flowing through the inductor 915 and a current flowing through the inductor 925 are configured so as to reduce power losses through flux cancellation.

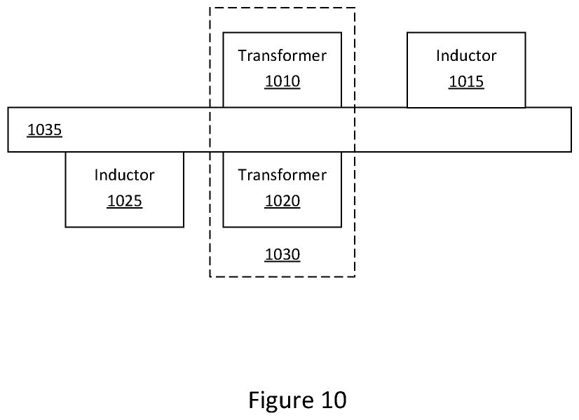

FIG. 10 illustrates a fourth implementation of the layout of the bidirectional power conversion system in accordance with various embodiments of the present disclosure. The bidirectional power conversion system comprises a first power converter and a second power converter. The first power converter is on a first side of a printed circuit board 1035. The second power converter is on a second side of the printed circuit board 1035. As shown in FIG. 10, the first side is a top side of the printed circuit board 1035. The second side is a bottom side of the printed circuit board 1035. The first power converter comprises a transformer 1010 and an inductor 1015. The transformer 1010 and the inductor 1015 are coupled in cascade between a first terminal and a second terminal. The second power converter comprises a transformer 1020 and an inductor 1025. The transformer 1020 and the inductor 1025 are coupled in cascade between the second terminal and a third terminal.

In some embodiments, the transformer 1010 is magnetically coupled to the transformer 1020 to form a coupled magnetic device 1030. The inductor 1015 and the inductor 1025 are on opposite sides of the coupled magnetic device 1030. As shown in FIG. 10, the transformer 1010 is directly over the transformer 1020. These two transformers are separated by the printed circuit board 1035. As shown in FIG. 10, a first side of the transformer 1010 is vertically aligned with a first side of the transformer 1020. A second side of the transformer 1010 is vertically aligned with a second side of the transformer 1020. The arrangement shown in FIG. 10 helps to reduce EMI. More particularly, radiation EMI of the transformer 1010 and radiation EMI of the transformer 1020 cancel each other out.

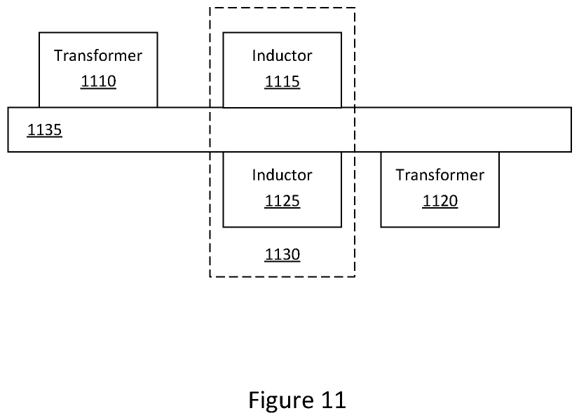

FIG. 11 illustrates a fifth implementation of the layout of the bidirectional power conversion system in accordance with various embodiments of the present disclosure. The bidirectional power conversion system comprises a first power converter and a second power converter. The first power converter is on a first side of a printed circuit board 1135. The second power converter is on a second side of the printed circuit board 1135. As shown in FIG. 11, the first side is a top side of the printed circuit board 1135. The second side is a bottom side of the printed circuit board 1135. The first power converter comprises a transformer 1110 and an inductor 1115. The transformer 1110 and the inductor 1115 are coupled in cascade between a first terminal and a second terminal. The second power converter comprises a transformer 1120 and an inductor 1125. The transformer 1120 and the inductor 1125 are coupled in cascade between the second terminal and a third terminal.

In some embodiments, the inductor 1115 is magnetically coupled to the inductor 1125 to form a coupled magnetic device 1130. The transformer 1110 and the transformer 1120 are on opposite sides of the coupled magnetic device 1130. As shown in FIG. 11, the inductor 1115 is directly over the inductor 1125. These two inductors are separated by the printed circuit board 1135. As shown in FIG. 11, a first side of the inductor 1115 is vertically aligned with a first side of the inductor 1125. A second side of the inductor 1115 is vertically aligned with a second side of the inductor 1125. The arrangement shown in FIG. 11 helps to reduce EMI. More particularly, radiation EMI of the inductor 1115 and radiation EMI of the inductor 1125 cancel each other out.

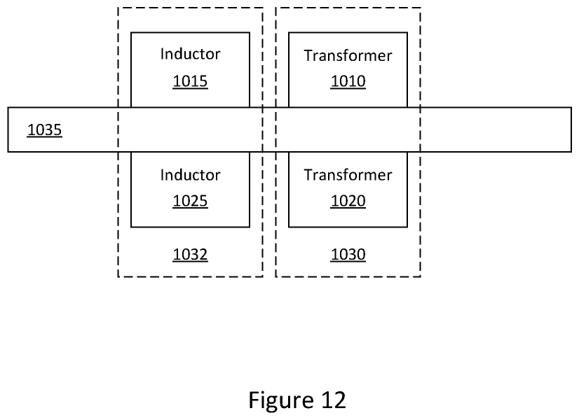

FIG. 12 illustrates a sixth implementation of the layout of the bidirectional power conversion system in accordance with various embodiments of the present disclosure. The sixth implementation of the layout of the bidirectional power conversion system is similar to the fourth implementation of the layout of the bidirectional power conversion system shown in FIG. 10 except that the inductor 1015 is placed on the left side of the transformer 1010. Through this layout arrangement, the inductor 1015 is magnetically coupled to the inductor 1025 to form a coupled magnetic device 1032. As shown in FIG. 12, the inductor 1015 is directly over the inductor 1025. These two inductors are separated by the printed circuit board 1035. As shown in FIG. 12, a first side of the inductor 1015 is vertically aligned with a first side of the inductor 1025. A second side of the inductor 1015 is vertically aligned with a second side of the inductor 1025. The arrangement shown in FIG. 12 helps to reduce EMI. More particularly, radiation EMI of the inductor 1015 and radiation EMI of the inductor 1025 cancel each other out.

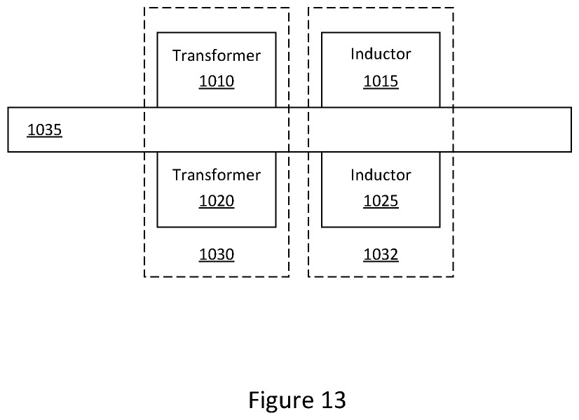

FIG. 13 illustrates a seventh implementation of the layout of the bidirectional power conversion system in accordance with various embodiments of the present disclosure. The seventh implementation of the layout of the bidirectional power conversion system is similar to the fourth implementation of the layout of the bidirectional power conversion system shown in FIG. 10 except that the inductor 1025 is placed on the right side of the transformer 1020. Through this layout arrangement, the inductor 1015 is magnetically coupled to the inductor 1025 to form a coupled magnetic device 1032. As shown in FIG. 13, the inductor 1015 is directly over the inductor 1025. These two inductors are separated by the printed circuit board 1035. As shown in FIG. 13, a first side of the inductor 1015 is vertically aligned with a first side of the inductor 1025. A second side of the inductor 1015 is vertically aligned with a second side of the inductor 1025. The arrangement shown in FIG. 13 helps to reduce EMI. More particularly, radiation EMI of the inductor 1015 and radiation EMI of the inductor 1025 cancel each other out.

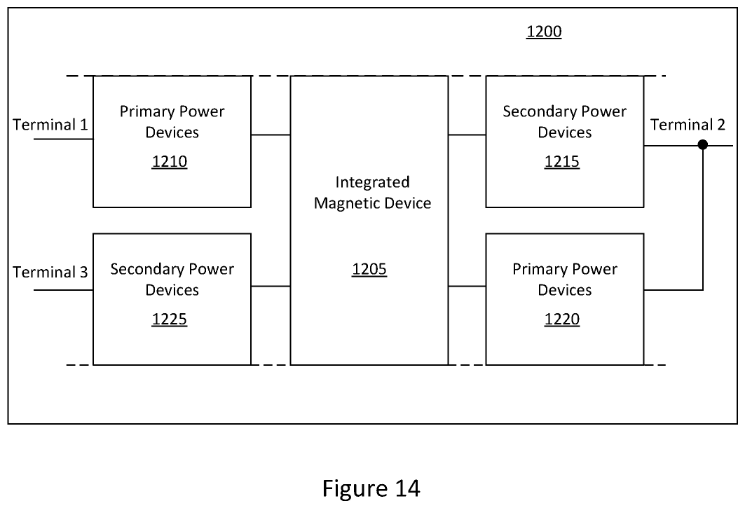

FIG. 14 illustrates an eighth implementation of the layout of the bidirectional power conversion system in accordance with various embodiments of the present disclosure. The bidirectional power conversion system comprises a first power converter and a second power converter. The first power converter comprises primary power devices 1210, a first transformer and secondary power devices 1215. The second power converter comprises primary power devices 1220, a second transformer and secondary power devices 1225. The first transformer and the second transformer are implemented on a same magnetic core. The first transformer and the second transformer form an integrated magnetic device 1205. In some embodiments, the first transformer is of a first magnetic path. The second transformer is of a second magnetic path. The first magnetic path is independent from the second magnetic path. Alternatively, the first transformer and the second transformer share a same magnetic path.

In alternative embodiments, the first power converter comprises primary power devices 1210, a first transformer, secondary power devices 1215 and a first inductor. The second power converter comprises primary power devices 1220, a second transformer, secondary power devices 1225 and a second inductor. The first transformer, the second transformer, the first inductor and the second inductor are implemented on a same magnetic core. The first transformer, the second transformer, the first inductor and the second inductor form an integrated magnetic device 1205. In some embodiments, the first transformer is of a first magnetic path. The second transformer is of a second magnetic path. The first magnetic path is independent from the second magnetic path. Alternatively, the first transformer and the second transformer share a same magnetic path.

As shown in FIG. 14, the primary power devices 1210 are on the left upper portion with reference to the integrated magnetic device 1205. The secondary power devices 1215 are on the right upper portion with reference to the integrated magnetic device 1205. The primary power devices 1220 are on the right lower portion with reference to the integrated magnetic device 1205. The secondary power devices 1225 are on the left lower portion with reference to the integrated magnetic device 1205. These four power device areas are symmetrical with reference to the integrated magnetic device 1205.

Furthermore, the rectangle 1210 represents the area occupied by the primary power devices of the first converter. The rectangle 1215 represents the area occupied by the second power devices of the first converter. The rectangle 1220 represents the area occupied by the primary power devices of the second converter. The rectangle 1225 represents the area occupied by the secondary power devices of the second converter. The rectangle 1205 represents the area occupied by the integrated magnetic device 1205. As indicated by the dashed line in FIG. 14, a longer side of the rectangle 1210 and a longer side of the rectangle 1215 are aligned with an upper side of the rectangle 1205. Likewise, as indicated by the dashed line in FIG. 14, a longer side of the rectangle 1220 and a longer side of the rectangle 1225 are aligned with a lower side of the rectangle 1205. One advantageous feature of having this layout configuration is the alignments described above provide a convenient solution for the design of the heat sinks applied to the bidirectional power conversion system.

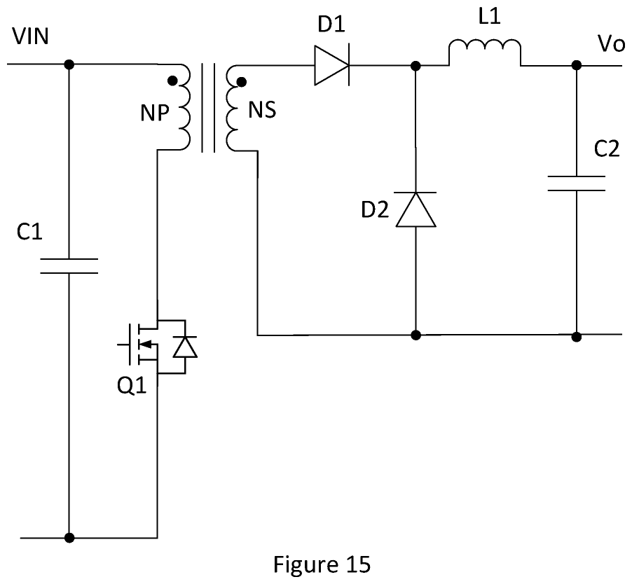

FIG. 15 illustrates a schematic diagram of a first implementation of the power converters of the bidirectional power conversion system in accordance with various embodiments of the present disclosure. In some embodiments, at least one of the first power converter and the second power converter described above is implemented as an isolated power converter such as a forward converter shown in FIG. 15.

The primary side power network of the isolated power converter comprises an input capacitor C1 and a switch Q1 connected in series with a primary winding NP of a transformer. The secondary side power network of the isolated power converter is coupled between a secondary side of the transformer and an output terminal. In particular, the secondary side power network comprises a rectifier and a filter connected in cascade between the secondary side of the transformer and the output terminal.

The rectifier comprises a first rectifier diode D1 and a second rectifier diode D2. The filter comprises an output inductor L1 and the output capacitor C2. As shown in FIG. 15, an anode of the first rectifier diode D1 is connected to a first terminal of a secondary winding NS of the transformer. An anode of the second rectifier diode D2 is connected to a second terminal of the secondary winding NS of the transformer. A cathode of the first rectifier diode D1 and a cathode of the second rectifier diode D2 are connected together and further connected to a first terminal of the output inductor L1. A second terminal of the output inductor L1 is connected to a first terminal of the output capacitor C2. A second terminal of the output capacitor C2 is connected to the second terminal of the secondary winding NS of the transformer. As shown in FIG. 15, Q1 and NP form a primary side circuit of a forward converter. D1, D2, L1 and C2 form a secondary side circuit of the forward converter.

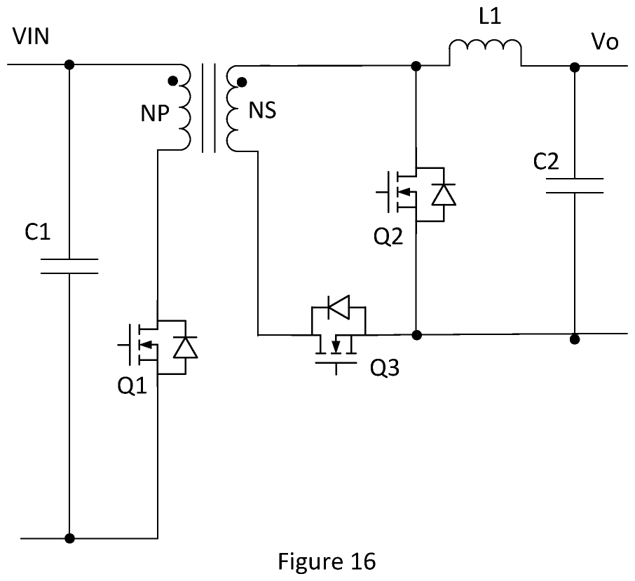

FIG. 16 illustrates a schematic diagram of a second implementation of the power converters of the bidirectional power conversion system in accordance with various embodiments of the present disclosure. The second implementation of the power converters shown in FIG. 16 is similar to the first implementation of the power converters shown in FIG. 15 except that the first rectifier diode and the second rectifier diode are replaced by two rectifier switches, respectively. It should be noted that replacement shown in FIG. 16 is merely an example. A person skilled in the art would understand there are many variations. For example, the first rectifier diode and the second rectifier diode are replaced by two MOSFET switches, a combination of MOSEFT switches and diodes, any combinations thereof and the like.

As shown in FIG. 16, the rectifier comprises a first rectifier switch Q2 and a second rectifier switch Q3. The filter comprises an output inductor L1 and an output capacitor C2. A drain of the first rectifier switch Q2 is connected to a first terminal of a secondary winding NS of the transformer. A drain of the second rectifier switch Q3 is connected to a second terminal of the secondary winding NS of the transformer. A source of the first rectifier switch Q2 and a source of the second rectifier switch Q3 are connected together and further connected to a second terminal of the output capacitor C2. A first terminal of the output inductor L1 is connected to the first terminal of the secondary winding NS of the transformer. A first terminal of the output capacitor C2 is connected to a second terminal of the output inductor L1.

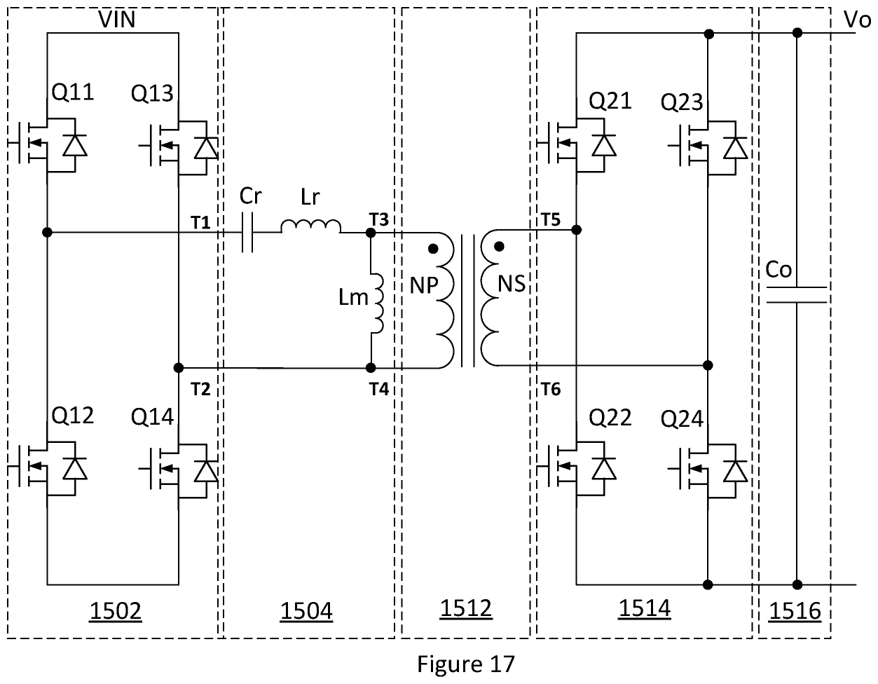

FIG. 17 illustrates a schematic diagram of a third implementation of the power converters of the bidirectional power conversion system in accordance with various embodiments of the present disclosure. In some embodiments, at least one of the first power converter and the second power converter is implemented as an inductor-inductor-capacitor (LLC) resonant converter. The LLC resonant converter comprises a switch network 1502, a resonant tank 1504, a transformer 1512, a rectifier 1514 and an output filter 1516. As shown in FIG. 17, the switch network 1502, the resonant tank 1504, the transformer 1512, the rectifier 1514 and the output filter 1516 are coupled to each other and connected in cascade between an input dc power source VIN and a load (not shown) coupled to the output of the LLC resonant converter.

The switch network 1502 includes four switching elements, namely Q11, Q12, Q13 and Q14. As shown in FIG. 17, a first pair of switching elements Q11 and Q12 are connected in series. A second pair of switching elements Q13 and Q14 are connected in series. The common node of the switching elements Q11 and Q12 is coupled to a first input terminal T1 of the resonant tank 1504. Likewise, the common node of the switching elements Q13 and Q14 is coupled to a second input terminal T2 of the resonant tank 1504.

FIG. 17 further illustrates the resonant tank 1504 is coupled between the switch network 1502 and the transformer 1512. The resonant tank 1504 is formed by a series resonant inductor Lr, a series resonant capacitor Cr and a parallel inductance Lm. As shown in FIG. 17, the series resonant inductor Lr and the series resonant capacitor Cr are connected in series and further coupled to the primary side of the transformer 1512.

It should be noted while FIG. 17 shows the series resonant inductor Lr is an independent component, the series resonant inductor Lr may be replaced by the leakage inductance of the transformer 1512. In other words, the leakage inductance (not shown) may function as the series resonant inductor Lr.

It should further be noted while FIG. 17 shows the resonant tank is placed on the primary side of the LLC resonant converter, this diagram is merely an example. A person skilled in the art will recognize many variations, alternatives and modifications. For example, the resonant tank may be placed on the secondary side. Furthermore, the resonant tank may be placed on both sides of the transformer 1512.

The transformer 1512 may be of a primary winding NP and a secondary winding NS. The primary winding is coupled to terminals T3 and T4 of the resonant tank 1504 as shown in FIG. 17. The secondary winding is coupled to the output of the LLC resonant converter through the rectifier 1514, which is a full-bridge rectifier comprising switches Q21, Q22, Q23 and Q24.

As shown in FIG. 17, switches Q21 and Q22 are connected in series and further coupled between two terminals of the output capacitor Co. Switches Q23 and Q24 are connected in series and further coupled between the two terminals of the output capacitor Co. The common node T5 of the switches Q21 and Q22 is coupled to a first terminal of the secondary winding of the transformer 1512. Likewise, the common node T6 of the switches Q23 and Q24 is coupled to a second terminal of the secondary winding of the transformer 1512.

It should be noted the transformer structure shown in FIG. 17 is merely an example. One person skilled in the art will recognize many alternatives, variations and modification. For example, the secondary side of the transformer 1512 may be a center tapped transformer winding. As a result, the secondary side may employ a synchronous rectifier formed by two switching elements. The operation principle of a synchronous rectifier coupled to a center tapped transformer winding is well known, and hence is not discussed in further detail herein to avoid repetition.

It should further be noted that the power topology of the LLC resonant converter may be not only applied to the rectifier as shown in FIG. 17, but also applied to other secondary configurations, such as voltage doubler rectifiers, current doubler rectifiers, any combinations thereof and/or the like.

In operation, when the switching frequency of the LLC resonant converter is equal to the resonant frequency of the resonant tank of the LLC resonant converter, the LLC resonant converter may have a unity system gain. On the other hand, when the switching frequency of the LLC resonant converter is higher than the resonant frequency, the LLC resonant converter is of a lower system gain.

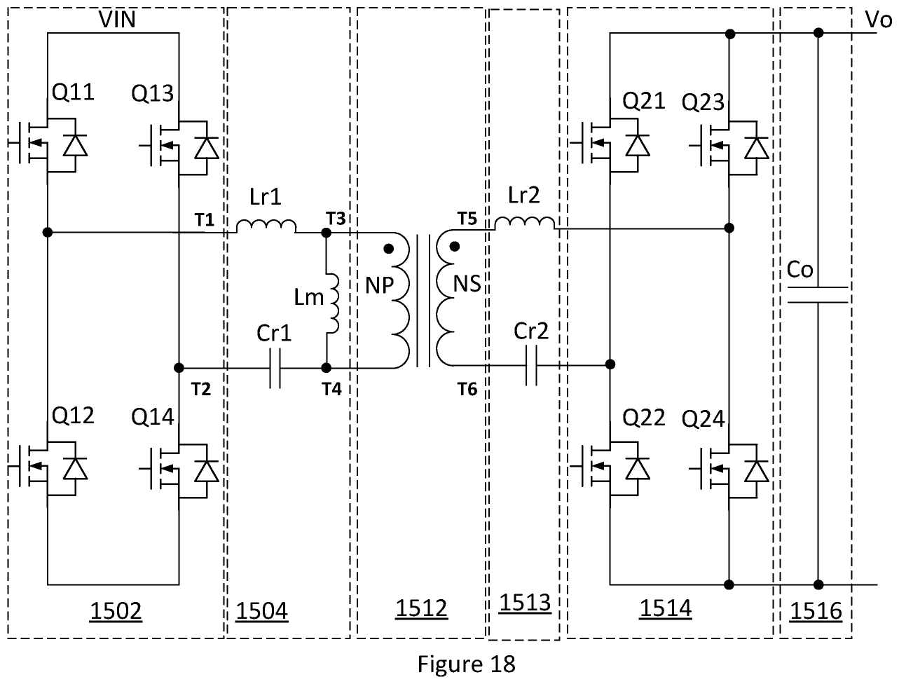

FIG. 18 illustrates a schematic diagram of a fourth implementation of the power converters of the bidirectional power conversion system in accordance with various embodiments of the present disclosure. The fourth implementation of the power converters shown in FIG. 18 is similar to the third implementation of the power converters shown in FIG. 17 except that one more resonant tank is employed to further improve the performance of the power converters. As shown in FIG. 18, Lr2 and Cr2 form a secondary side resonant tank 1513.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion system comprising:
from a first port to a second port, a first power converter configured to provide power across a first isolation barrier; and
from the second port to a third port, a second power converter configured to provide power across a second isolation barrier, wherein:
the first power converter and the second power converter mounted adjacent to each other on a platform; and
at least one auxiliary component is shared by the first power converter and the second power converter.

2. The power conversion system of claim 1, wherein:
the first port is configured to receive a dc input voltage;
the second port is configured to maintain a dc voltage; and
the third port is configured to generate a de output voltage, and wherein:
in a first phase of the power conversion system, the power flows from the first port to the second port; and
in a second phase of the power conversion system, the power flows from the second port to the third port.

3. The power conversion system of claim 1, wherein:
the first port is configured to receive an ac input voltage;
the second port is configured to maintain a de voltage; and
the third port is configured to generate a dc output voltage, and wherein:
in a first phase of the power conversion system, the power flows from the first port to the second port; and
in a second phase of the power conversion system, the power flows from the second port to the third port.

4. The power conversion system of claim 1, wherein:
the first port is configured to receive an ac input voltage;
the second port is configured to maintain a dc voltage; and
the third port is configured to generate an ac output voltage, and wherein:
in a first phase of the power conversion system, the power flows from the first port to the second port; and
in a second phase of the power conversion system, the power flows from the second port to the third port.

5. The power conversion system of claim 1, wherein:
the first port is configured to receive a dc input voltage;
the second port is configured to maintain a de voltage; and
the third port is configured to generate an ac output voltage, and wherein:
in a first phase of the power conversion system, the power flows from the first port to the second port; and
in a second phase of the power conversion system, the power flows from the second port to the third port.

6. The power conversion system of claim 1, wherein:
the platform is a PCB board; and
the first power converter and the second power converter are packaged in a same packaging house.

7. The power conversion system of claim 1, wherein:
the first power converter comprises a first magnetic component; and
the second power converter comprises a second magnetic component, and wherein:
the first magnetic component and the second magnetic component are integrated into one magnetic core structure; and
a current flowing through the first magnetic component and a current flowing through the second magnetic component are configured so as to reduce power losses through flux cancellation.

8. The power conversion system of claim 1, wherein:
primary side circuits of the first power converter and secondary side circuits of the second power converter, secondary side circuits of the first power converter and primary side circuits of the second power converter share a heat sink, and wherein the heat sink comprises an isolation barrier.

9. The power conversion system of claim 1, wherein:
primary side circuits of the first power converter and secondary side circuits of the second power converter share a first heat sink; and
secondary side circuits of the first power converter and primary side circuits of the second power converter share a second heat sink.

10. The power conversion system of claim 9, wherein:
a first controller is configured to control the primary side circuits of the first power converter and the secondary side circuits of the second power converter; and
a second controller is configured to control the secondary side circuits of the first power converter and the primary side circuits of the second power converter.

11. The power conversion system of claim 9, wherein:
a controller is configured to control the primary side circuits of the first power converter and the secondary side circuits of the second power converter directly, and control the secondary side circuits of the first power converter and the primary side circuits of the second power converter through an isolator.

12. The power conversion system of claim 1, wherein:
the first power converter and the second power converter share a same heat sink, and wherein an isolation layer is formed on the same heat sink.

13. The power conversion system of claim 1, wherein:
a battery is coupled to the second port, and wherein:
in a first phase of the power conversion system, the first power converter is configured to charge the battery; and
in a second phase of the power conversion system, the second power converter is configured to provide a discharge path for the battery.

14. The power conversion system of claim 1, wherein:
a power grid is coupled to the second port, and wherein:
in a first phase of the power conversion system, the first power converter is configured to provide power to the power grid; and
in a second phase of the power conversion system, the second power converter is configured to retrieve power from the power grid.

15. The power conversion system of claim 1, wherein:
an energy storage unit is coupled to the second port, and wherein:
in a first phase of the power conversion system, the first power converter is configured to charge the energy storage unit; and
in a second phase of the power conversion system, the second power converter is configured to provide a discharge path for the energy storage unit.

16. The power conversion system of claim 12, further comprising:
a selector circuit coupled between the first port and the third port, wherein the selector circuit is configured such that:
in the first phase of the power conversion system, the first port is separated from the third port; and
in the second phase of the power conversion system, the first port is connected to the third port.

17. The power conversion system of claim 1, wherein:
the first power converter and the second power converter share a same auxiliary power source.

18. The power conversion system of claim 1, wherein:
on the platform, the first isolation barrier is vertically aligned with the second isolation barrier.

19. The power conversion system of claim 1, wherein:
the first power converter comprises a first transformer; and
the second power converter comprises a second transformer, and wherein the first transformer and the second transformer are integrated on a same magnetic core.

20. The power conversion system of claim 1, wherein:
the first power converter is a first forward converter comprising a first inductor; and
the second power converter is a second forward converter comprising a second inductor, and wherein the first inductor and the second inductor share one magnetic core structure.

21. The power conversion system of claim 1, wherein:
the first power converter is a first LLC converter comprising a first resonant tank; and
the second power converter is a second LLC converter comprising a second resonant tank, and wherein a first magnetic component of the first resonant tank and a second magnetic component of the second resonant tank share one magnetic core structure.

22. A system comprising:
a first power converter coupled between a first terminal and a second terminal of the system, wherein the first power converter is configured to provide power across a first isolation barrier; and
a second power converter coupled between the second terminal and a third terminal of the system, wherein the second power converter is configured to provide power across a second isolation barrier, and wherein the first power converter and the second power converter mounted adjacent to each other on a printed circuit board.

23. The system of claim 22, wherein:
the first power converter comprises a first transformer and a first inductor; and
the second power converter comprises a second transformer and a second inductor, and wherein the first transformer and the second transformer are integrated into a same magnetic core structure to reduce electromagnetic interference through flux cancellation.

24. A bidirectional power system comprising:
a first power converter coupled between a first terminal and a second terminal on a printed circuit board, wherein the first power converter is configured to provide power from the first terminal to the second terminal across a first isolation barrier; and
a second power converter coupled between the second terminal and a third terminal on the printed circuit board, wherein the second power converter is configured to provide power from the second terminal to the third terminal across a second isolation barrier, and wherein:
the first power converter comprises at least one first magnetic device; and
the second power converter comprises at least one second magnetic device, and wherein the at least one first magnetic device is magnetically coupled to the at least one second magnetic device.

25. The bidirectional power system of claim 24, wherein:
the at least one first magnetic device is magnetically coupled to the at least one second magnetic device to form an integrated magnetic device.

26. The bidirectional power system of claim 25, further comprising:
a first rectangular layout area occupied by primary side power devices of the first power converter;
a second rectangular layout area occupied by secondary side power devices of the first power converter;
a third rectangular layout area occupied by primary side power devices of the second power converter;
a fourth rectangular layout area occupied by secondary side power devices of the second power converter; and
a fifth rectangular layout area occupied by the integrated magnetic device, and wherein:
An edge of the first rectangular layout area and an edge of the second rectangular layout area are aligned with a first edge of the fifth rectangular layout area; and
An edge of the third rectangular layout area and an edge of the fourth rectangular layout area are aligned with a second edge of the fifth rectangular layout area.
